(19) United States
(12) Patent Application Publication
(10) Pub. No.: US 2025/0373452 A1
(43) Pub. Date: Dec. 4, 2025

(54) METHOD AND DEVICE OF MULTIMEDIA PLAYBACK FOR VIRTUAL SYSTEM

(71) Applicant: Samsung Electronics Co., Ltd., Suwon-si (KR)

(72) Inventors: Ran LIU, Nanjing (CN); Chuanji TANG, Nanjing (CN); Zuolong WANG, Nanjing (CN); Ye SUN, Nanjing (CN)

(21) Appl. No.: 19/297,450

(22) Filed: Aug. 12, 2025

Related U.S. Application Data
(63) Continuation of application No. PCT/KR2024/006501, filed on May 13, 2024.

(30) Foreign Application Priority Data
Jun. 29, 2023 (CN) 202310794669.1

(51) Int. Cl. H04L 9/32

(52) U.S. Cl. CPC H04L 9/3268

(57) ABSTRACT

A method and a device of multimedia playback for a virtual system are provided. The method of multimedia playback for a virtual system includes establishing a secure communication channel between the virtual system and a host system, acquiring a license file for acquiring encrypted multimedia data in a case that an application in the virtual system requesting access to the host system passes authentication of the host system, acquiring the encrypted multimedia data based on the license file, transmitting the encrypted multimedia data to the host system for decryption based on the secure communication channel, and acquiring decrypted multimedia data obtained by decryption by the host system, and playing back the decrypted multimedia data.

### CROSS-REFERENCE TO RELATED APPLICATION(S)

This application is a continuation application, claiming priority under 35 U.S.C. § 365 (c), of an International application No. PCT/KR2024/006501, filed on May 13, 2024, which is based on and claims the benefit of a Chinese patent application number 202310794669.1, filed on Jun. 29, 2023, in the Chinese Intellectual Property Office, the disclosure of which is incorporated by reference herein in its entirety.

### BACKGROUND

### 1. Field

The disclosure relates to a computer technology field. More particularly, the disclosure relates to a method and a device of multimedia playback for a virtual system, and an operation method and a device performed by a host system.

### 2. Description of Related Art

In recent years, virtualization technology has gradually become the focus of people's attention and is receiving more and more attention and importance. Virtualization technology is able to run another operating system and its application scope in one operating system, which can greatly expand the application scenarios of current operating systems.

As people pay more attention to copyright, digital rights management (DRM) is more and more widely used. When playing back various media files, the media files can be protected by encryption through digital rights management. However, virtual systems cannot simulate a trusted execution environment and can only decrypt digital rights management resources using software with a relatively low level of security, which cannot meet the requirements of high copyright. Therefore, there is a need for multimedia playback solutions that can support higher security level scenarios to increase the strength of data protection, thereby meeting the requirements of high copyright multimedia streaming.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device of multimedia playback for a virtual system, and an operation method and device performed by a host system, so as to increase the strength of data protection, thereby meeting the requirements of high copyright multimedia streaming.

Additional aspects will be set forth in part in the description which follows and, in part, will be apparent from the description, or may be learned by practice of the presented embodiments.

In accordance with an aspect of the disclosure, a method of multimedia playback for a virtual system is provided. The method and device of multimedia playback for a virtual system includes establishing a secure communication channel between the virtual system and a host system, acquiring a license file for acquiring encrypted multimedia data in a case that an application in the virtual system requesting access to the host system passes authentication of the host system, acquiring the encrypted multimedia data based on the license file, transmitting the encrypted multimedia data to the host system for decryption based on the secure communication channel, and acquiring decrypted multimedia data obtained by decryption by the host system, and playing back the decrypted multimedia data.

Alternatively, the acquiring of the license file for acquiring the encrypted multimedia data in the case that the application in the virtual system requesting access to the host system passes the authentication of the host system includes in response to the application requesting access to the host system, determining, by the host system, whether the application is authorized for access by the host system, in a case of determining that the application is authorized for the access by the host system, acquiring a certificate for authenticating the application by the host system, acquiring the license file, in the case that the host system is determined to be authenticated based on the certificate.

Alternatively, the acquiring of the certificate includes invoking a second digital rights management service of the host system by a first digital rights management service of the virtual system to acquire the certificate.

Alternatively, the sending of the encrypted multimedia data to the host system for decryption based on the secure communication channel includes sending the encrypted multimedia data to the host system by means of data pointer address encryption in the secure communication channel.

Alternatively, the invoking of the second digital rights management service of the host system by the first digital rights management service of the virtual system to acquire the certificate includes downloading the certificate from an authentication server for authentication by invoking the second digital rights management service of the host system by the first digital rights management service of the virtual system, wherein the downloaded certificate is stored in the host system.

Alternatively, the acquiring of the license file includes invoking the second digital rights management service by the first digital rights management service to generate a license request message, and sending the license request message to a license server to obtain the license file.

Alternatively, the sending of the encrypted multimedia data to the host system for decryption based on the secure communication channel includes determining whether to decrypt the encrypted multimedia data in a trusted execution environment, according to requirements of a usage scenario of the application, sending the encrypted multimedia data to the host system for decrypting the encrypted multimedia data in the trusted execution environment of the host system, when it is determined to decrypt the encrypted multimedia data in the trusted execution environment.

Alternatively, the method further includes sending a handle key and/or a data pointer address for decrypting the multimedia data to the host system based on the secure communication channel, wherein the handle key and/or the data pointer address for decrypting the multimedia data is in an encrypted state.

Alternatively, the sending of the encrypted multimedia data to the host system by means of the data pointer address encryption includes processing an original value and a key of the data pointer address of the encrypted multimedia data by an encryption algorithm to obtain a cipher text, inserting a first verification code at a predetermined position of the cipher text to obtain a processed cipher text, sending the processed cipher text to the host system, wherein, when decrypting the encrypted multimedia data in the trusted execution environment of the host system, the host system decrypts the data pointer address of the encrypted multimedia data by the decryption algorithm to obtain a second verification code, matches the second verification code with the first verification code, and obtains the data pointer address of the encrypted multimedia data in a case of a successful match between the second verification code and the first verification code.

In accordance with another aspect of the disclosure, an operation method performed by a host system is provided. The operation method performed by a host system includes establishing a secure communication channel between the host system and a virtual system, in response to receiving an access request from an application in the virtual system, authenticating the application, receiving the encrypted multimedia data based on the secure communication channel in a case that the application is authenticated, decrypting the encrypted multimedia data.

Alternatively, the authenticating of the application includes determining whether the application is authorized to make an access, in a case of determining that the application is authorized to make an access, acquiring a certificate for authenticating the application, wherein the virtual system acquires a license file for acquiring the encrypted multimedia data based on the certificate, acquires the encrypted multimedia data based on the license file, and sends the encrypted multimedia data to the host system.

Alternatively, the decrypting of the encrypted multimedia data includes decrypting the encrypted multimedia data in a trusted execution environment.

Alternatively, the decrypting of the encrypted multimedia data in a trusted execution environment includes decrypting a data pointer address of the encrypted multimedia data by a decryption algorithm to obtain a second verification code, matching the second verification code with a first verification code, acquiring the data pointer address of the encrypted multimedia data in a case of successful matching of the second verification code with the first verification code.

Alternatively, the method further includes receiving a handle key and/or a data pointer address for decrypting the multimedia data based on the secure communication channel, wherein the handle key and/or the data pointer address for decrypting the multimedia data is in an encrypted state.

In accordance with another aspect of the disclosure, a device of multimedia playback for a virtual system is provided. The device of multimedia playback for a virtual system includes a channel establisher configured to establish a secure communication channel between the virtual system and a host system, a license file acquirer configured to acquire a license file for acquiring encrypted multimedia data in a case that an application in the virtual system requesting access to the host system passes authentication of the host system, an encrypted data acquirer configured to acquire the encrypted multimedia data based on the license file, a data decrypter configured to send the encrypted multimedia data to the host system for decryption based on the secure communication channel, and a multimedia playing back circuit configured to acquire decrypted multimedia data obtained by decryption by the host system, and playback the decrypted multimedia data.

Alternatively, the license file acquiring unit is configured to determine, by the host system, whether the application is authorized for access by the host system in response to the application requesting access to the host system, in a case of determining that the application is authorized for the access by the host system, to acquire a certificate for authenticating the application by the host system, and to acquire the license file, in the case that the host system is determined to be authenticated based on the certificate.

Alternatively, the license file acquiring unit is configured to invoke a second digital rights management service of the host system by a first digital rights management service of the virtual system to acquire the certificate.

Alternatively, the data decrypting unit may be configured to send the encrypted multimedia data to the host system by means of data pointer address encryption in the secure communication channel.

Alternatively, the license file acquiring unit is configured to download the certificate from an authentication server for authentication by invoking the second digital rights management service of the host system by the first digital rights management service of the virtual system, wherein the downloaded certificate is stored in the host system.

Alternatively, the license file acquiring unit is configured to invoke the second digital rights management service by the first digital rights management service to generate a license request message, and to send the license request message to a license server to obtain the license file.

Alternatively, the multimedia playing back unit is configured to determine whether to decrypt the encrypted multimedia data in a trusted execution environment, according to requirements of a usage scenario of the application, and to send the encrypted multimedia data to the host system for decrypting the encrypted multimedia data in the trusted execution environment of the host system, when it is determined to decrypt the encrypted multimedia data in the trusted execution environment.

Alternatively, the device further includes a sending unit, configured to send a handle key and/or a data pointer address for decrypting the multimedia data to the host system based on the secure communication channel, wherein the handle key and/or the data pointer address for decrypting the multimedia data is in an encrypted state.

Alternatively, the multimedia playing back unit is configured to process an original value and a key of the data pointer address of the encrypted multimedia data by an encryption algorithm to obtain a cipher text, to insert a first verification code at a predetermined position of the cipher text to obtain a processed cipher text, and to send the processed cipher text to the host system. Wherein, when decrypting the encrypted multimedia data in the trusted execution environment of the host system, the host system decrypts the data pointer address of the encrypted multimedia data by the decryption algorithm to obtain a second verification code, matches the second verification code with the first verification code, and obtains the data pointer address of the encrypted multimedia data in a case of a successful match between the second verification code and the first verification code.

In accordance with another aspect of the disclosure, an operation device performed by a host system is provided. The operation device performed by a host system includes a channel establishing unit configured to establish a secure communication channel between the host system and a virtual system, an authenticating unit configured to, in response to receiving an access request from an application in the virtual system, authenticate the application, an encrypted data receiving unit configured to receive the encrypted multimedia data based on the secure communication channel in a case that the application is authenticated, a data decrypting unit configured to decrypt the encrypted multimedia data.

Alternatively, the authenticating unit is configured to determine whether the application is authorized to make an access, to acquire a certificate for authenticating the application in a case of determining that the application is authorized to make an access, wherein the virtual system acquires a license file for acquiring the encrypted multimedia data based on the certificate, acquires the encrypted multimedia data based on the license file, and sends the encrypted multimedia data to the host system.

Alternatively, the data decrypting unit is configured to decrypt the encrypted multimedia data in a trusted execution environment.

Alternatively, the data decrypting unit is configured to decrypt a data pointer address of the encrypted multimedia data by a decryption algorithm to obtain a second verification code, to match the second verification code with a first verification code, to acquire the data pointer address of the encrypted multimedia data in a case of successful matching of the second verification code with the first verification code.

Alternatively, the device further includes a receiving unit, configured to receive a handle key and/or a data pointer address for decrypting the multimedia data based on the secure communication channel, wherein the handle key and/or the data pointer address for decrypting the multimedia data is in an encrypted state.

In accordance with another aspect of the disclosure, one or more non-transitory computer-readable storage media storing one or more computer programs including computer-executable instructions that, when executed by one or more processors of a multimedia playback device individually or collectively, cause the multimedia playback device to perform operations are provided. The operations includes establishing a secure communication channel between a virtual system and a host system, acquiring a license file for acquiring encrypted multimedia data in a case that an application in the virtual system requesting access to the host system passes authentication of the host system, acquiring the encrypted multimedia data based on the license file, transmitting the encrypted multimedia data to the host system for decryption based on the secure communication channel, and acquiring decrypted multimedia data obtained by decryption by the host system, and playing back the decrypted multimedia data.

According to the embodiments of the disclosure, there provides a computing device including at least one processor, and at least memory storing a computer program, wherein when the computer program is executed by the processor, a method according to the embodiments of the disclosure is implemented.

According to embodiments of the disclosure, there provides a computer program product, wherein instructions in the computer program product can be executed by a processor of the computer device to complete a method according to the embodiments of the disclosure.

The method and the device of multimedia playback for a virtual system according to the embodiments of the disclosure, by establishing a secure communication channel between the virtual system and a host system, acquiring a license file for acquiring encrypted multimedia data in a case that an application in the virtual system requesting access to the host system passes authentication of the host system, acquiring the encrypted multimedia data based on the license file, sending the encrypted multimedia data to the host system for decryption based on the secure communication channel, and acquiring decrypted multimedia data obtained by decryption by the host system, and playing back the decrypted multimedia data, thus it is possible to playback digital rights management resources with a higher level of security for copyright requirements in the virtual system by decrypting with the help of the host system, which improves the strength of data protection.

The operation method and the operation device performed by a host system according to the embodiments of the disclosure, by establishing a secure communication channel between the host system and a virtual system, authenticating the application in response to receiving an access request from an application in the virtual system, receiving the encrypted multimedia data based on the secure communication channel in a case that the application is authenticated, decrypting the encrypted multimedia data, it enables the playback of digital rights management resources with higher levels of security for copyright requirements in a virtual system, thereby increasing the strength of data protection.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a flow chart of a method of multimedia playback for a virtual system according to an embodiment of the disclosure;

FIG. 2 illustrates a schematic diagram of a method multimedia playback for a virtual system according to an embodiment of the disclosure;

FIG. 3 illustrates a schematic diagram of enhancing inter-system data transfer protection based on trusted data channels according to an embodiment of the disclosure;

FIG. 4 illustrates a schematic diagram of data pointer address encryption according to an embodiment of the disclosure;

FIG. 5 illustrates a schematic diagram of data pointer address decryption according to an embodiment of the disclosure;

FIG. 6 illustrates a schematic diagram of dynamically managing an application program of a virtual system using digital rights management of a host system, according to an embodiment of the disclosure;

FIG. 7 illustrates a schematic diagram of performing authentication using digital rights management of a host system, according to an embodiment of the disclosure;

FIG. 8 illustrates a flowchart of an operation method performed by a host system according to an embodiment of the disclosure;

FIG. 9 illustrates a block diagram of a device of multimedia playback for a virtual system according to an embodiment of the disclosure;

FIG. 10 illustrates a block diagram of a device of multimedia playback for a host system according to an embodiment of the disclosure; and

FIG. 11 illustrates a schematic diagram of a computing device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In related art, 1) the virtual system has many applications, and malicious applications frequently access to invoke the host system's digital rights management (DRM), which will take up too many resources; 2) while the host system has been authenticated by the DRM copyright holder's server, the virtual system needs to reapply for the authentication, which may not be authorized by the DRM copyright holder due to the lack of a trustworthy hardware environment; 3) when playing back DCM videos in the virtual system, because the virtual system cannot simulate the Trusted Execution Environment (TEE), it can only decrypt the DCM using software of a lower level, which cannot satisfy the requirements of high copyrights; 4) there is no complete solution to support the playback of multi-security levels, such as all the processes of the video are carried out in the Trusted Execution Environment (TEE) of the host system, and the decryption operation of the audio is done in the internal decryption of the virtual system; 5) although secure communication is established between the host system and the virtual system, there may be malicious programs that intercept or tamper with the data (e.g., obtaining the address of pointers in the shared memory), and the multimedia data is vulnerable to corruption.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

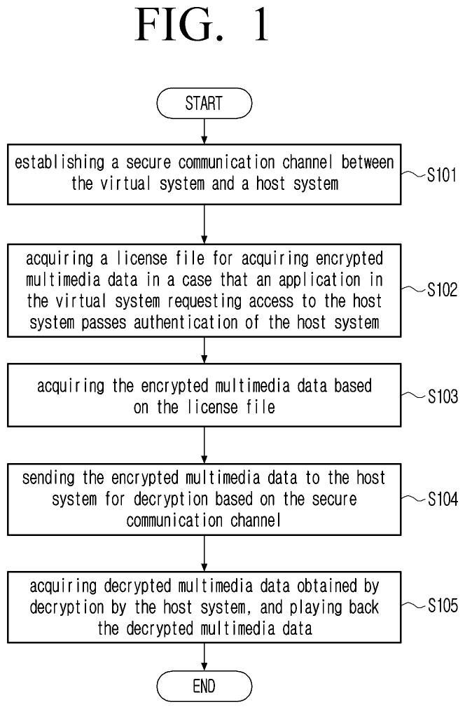

FIG. 1 illustrates a flow chart of a method of multimedia playback for a virtual system according to an embodiment of the disclosure.

Referring to FIG. 1, in operation S101, a secure communication channel is established between the virtual system and a host system.

Specifically, the virtual system supports the playback of digital rights-managed multimedia contents with a high-security level.

In operation S102, a license file for acquiring encrypted multimedia data is acquired in a case that an application in the virtual system requesting access to the host system passes authentication of the host system.

In the embodiment of the disclosure, the acquiring of the license file for acquiring the encrypted multimedia data in the case that the application in the virtual system requesting access to the host system passes the authentication of the host system may include: in response to the application requesting access to the host system, determining, by the host system, whether the application is authorized for access by the host system; in a case of determining that the application is authorized for the access by the host system, acquiring a certificate for authenticating the application by the host system; acquiring the license file, in the case that the host system is determined to be authenticated based on the certificate. Specifically, the host system needs to manage the authentication for access of the applications of the virtual system, authorize applications that have been registered in the host system to make an access, and the whitelist data of the applications is stored in the trusted execution environment to prevent from being modified.

In the embodiment of the disclosure, the acquiring of the certificate may include: invoking a second digital rights management service (for example, DRM2) of the host system by a first digital rights management service (for example, DRM1) of the virtual system to acquire the certificate.

It may be determined that an application is authorized for access by the host system by performing authentication management on the application by the host system. In the embodiment of the disclosure, the performing authentication management on the application by the host system may include: in the case that the application is determined to be a predetermined application, determining that the application is authorized to make an access by the host system. For example, the accessing of the applications in the virtual system to the host system's DRM is managed, and an application is denied to access to and use the DRM if it is not on the host system's DRM whitelist, which improves the host system's security and protects the limited resources of the DRM from being utilized.

In the embodiment of the disclosure, the invoking of the second digital rights management service of the host system by the first digital rights management service of the virtual system to acquire the certificate may include: downloading the certificate from an authentication server for authentication by invoking the second digital rights management service of the host system by the first digital rights management service of the virtual system. In the embodiment of the disclosure, the downloaded certificate is stored in the host system. Specifically, the first digital rights management service of the virtual system invokes the second digital rights management service of the host system for authentication, and the second digital rights management service downloads a certificate from the authentication server, and the downloaded certificate is stored in the host system.

In the embodiment of the disclosure, the acquiring of the license file may include: invoking the second digital rights management service by the first digital rights management service to generate a license request message, and sending the license request message to a license server to obtain the license file. For example, the first digital rights management service invokes the second digital rights management service to generate a request message for a license file and sends the message to a license server to obtain the license file, and then processes the license file for the application security level requirements.

In operation S103, the encrypted multimedia data is acquired based on the license file.

Specifically, the application downloads encrypted audio and video data from a media content server.

In operation S104, the encrypted multimedia data is sent to the host system for decryption based on the secure communication channel. For example, according to requirements of a usage scenario of the application, it is determined whether to decrypt data in a trusted execution environment, and decryption of the same media file using digital rights management with different security level requirements is supported.

In the embodiment of the disclosure, the method may further include: sending a handle key (for example, handle keys of individual modules) and/or a data pointer address for decrypting the multimedia data to the host system based on the secure communication channel, wherein the handle key and/or the data pointer address for decrypting the multimedia data is in an encrypted state. The host system obtains the correct handle key and data pointer address by decryption, in order to further improve the security of inter-system data transfer protection.

In the embodiment of the disclosure, the sending of the encrypted multimedia data to the host system for decryption based on the secure communication channel may include: sending the encrypted multimedia data to the host system by means of data pointer address encryption in the secure communication channel.

In the embodiment of the disclosure, the sending of the encrypted multimedia data to the host system for decryption based on the secure communication channel may include: determining whether to decrypt the encrypted multimedia data in a trusted execution environment, according to requirements of a usage scenario of the application; sending the encrypted multimedia data to the host system for decrypting the encrypted multimedia data in the trusted execution environment of the host system, when it is determined to decrypt the encrypted multimedia data in the trusted execution environment, thereby decrypting the encrypted multimedia data in the trusted execution environment of the host system. The multimedia data is put into shared memory, and an address pointer is transmitted by a trusted channel, after being encrypted, to the host system for decryption.

In the embodiment of the disclosure, the sending of the encrypted multimedia data to the host system by means of the data pointer address encryption may include: processing an original value and a key of the data pointer address of the encrypted multimedia data by an encryption algorithm to obtain a cipher text; inserting a first verification code at a predetermined position of the cipher text to obtain a processed cipher text; sending the processed cipher text to the host system. Herein, when decrypting the encrypted multimedia data in the trusted execution environment of the host system, the host system decrypts the data pointer address of the encrypted multimedia data by the decryption algorithm to obtain a second verification code; matches the second verification code with the first verification code; and obtains the data pointer address of the encrypted multimedia data in a case of a successful match between the second verification code and the first verification code.

In operation S105, decrypted multimedia data obtained by decryption by the host system is acquired, and the decrypted multimedia data is played back.

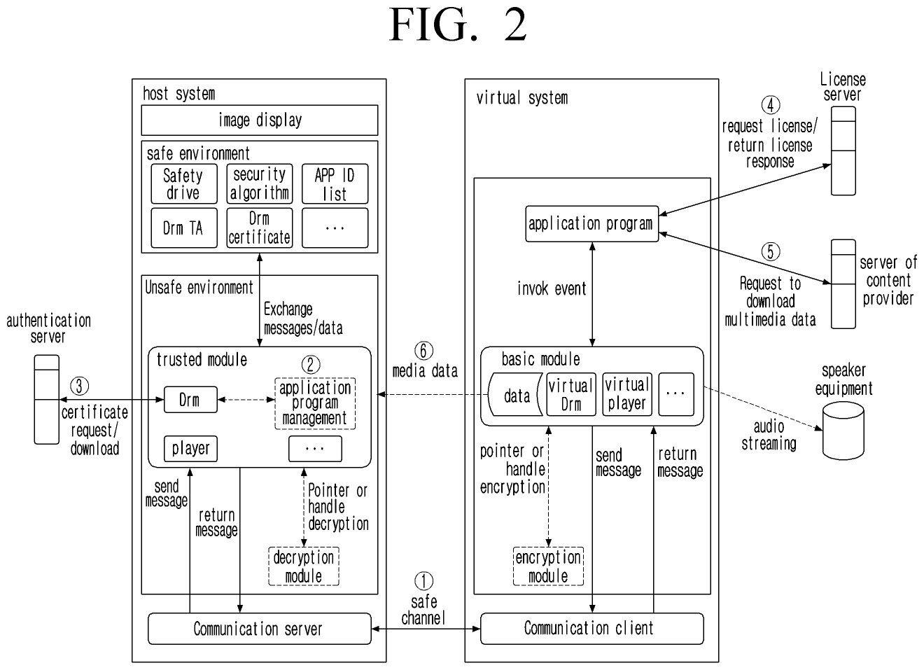

FIG. 2 illustrates a schematic diagram of a method multimedia playback for a virtual system according to an embodiment of the disclosure.

Referring to FIG. 2, at operation \textcircled{1}, a secure communication channel is established between the host system and the virtual system. The handle key and data pointer address of each module of the virtual system are encrypted, and the host system obtains the correct handle key and data pointer address by decryption, thereby further improving the security of inter-system data transmission protection.

At operation 2, the host system performs authentication management on the access of the applications of the virtual system, authorizes the access of the applications that have been registered in the host system, and the whitelist data of the applications is saved in the trusted execution environment to prevent from being modified.

At operation 33, the first digital rights management service DRM1 of the virtual system invokes the second digital rights management service DRM2 of the host system for authentication, and the second digital rights management service DRM2 downloads a certificate from a verification server, and the certificate is to be stored in the host system.

At operation 4, the first digital rights management service DRM1 invokes the second digital rights management service DRM2 to generate a license file (license) request message and sends the message to the license file server to obtain the license file (license), and then processes the license file (license) according to the application security level requirements.

At operation 5, the application downloads encrypted audio and video data from a media content server, determines whether to put the data into a trusted execution environment for decryption according to requirements of the application's usage scenario, and supports decryption of the same media file by using DRMs of digital rights management services with different security level requirements.

In operation 6, the multimedia data is put into shared memory, and an address pointer is transmitted through a trusted channel, after being encrypted, to the host system for decryption.

Data in each module of the virtual system can only be accessed by specified modules, for example, only the digital rights management service can obtain the correct pointer address of the virtual digital rights management data.

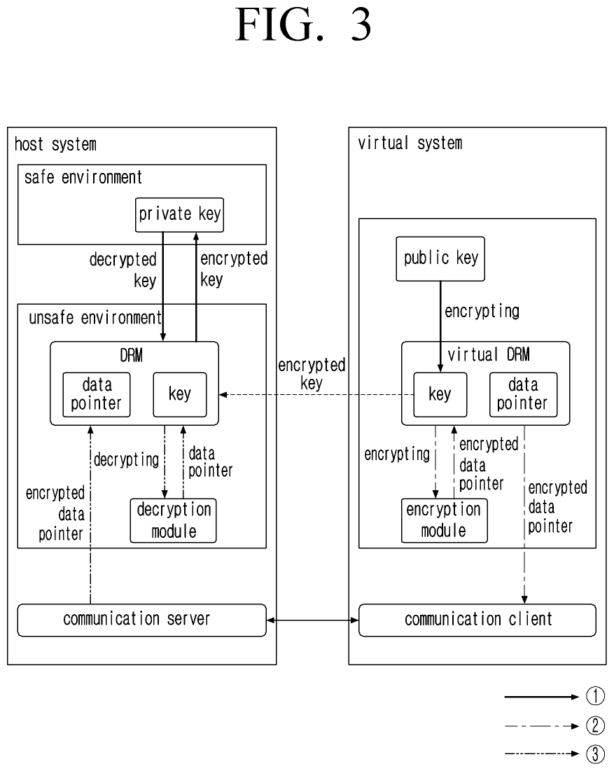

FIG. 3 illustrates a schematic diagram of enhancing inter-system data transfer protection based on trusted data channels according to an embodiment of the disclosure.

Referring to FIG. 3, in phase \textcircled{1}, the virtual digital rights management service DRM generates a unique handle key (for encrypting or decrypting a data pointer address), then encrypts the key using a public certificate, sends the encryption key to the host digital rights management service DRM using a secure channel, and decrypts the handle key using a private key of a trusted execution environment.

In phase 2, the virtual digital rights management service DRM invokes the encryption module to encrypt the data pointer address with the key, and then sends the encrypted data pointer address to the host system's digital rights management service DRM.

In phase 33, the host digital rights management service DRM invokes the decryption module to decrypt the encrypted data pointer using the handle key to obtain a correct pointer address.

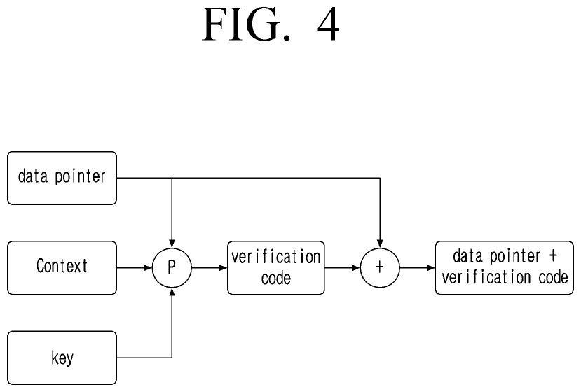

FIG. 4 illustrates a schematic diagram of data pointer address encryption according to an embodiment of the disclosure. Referring to FIG. 4, the Context is a context of, for example, 64 bits (which may be generated by a key), the original value of the pointer and, for example, a 128-bit key are encrypted by an encryption algorithm to obtain a 64-bit cipher text, a verification code is inserted as a high bit of the pointer after truncation, and the value of the pointer is validated prior to the pointer being used.

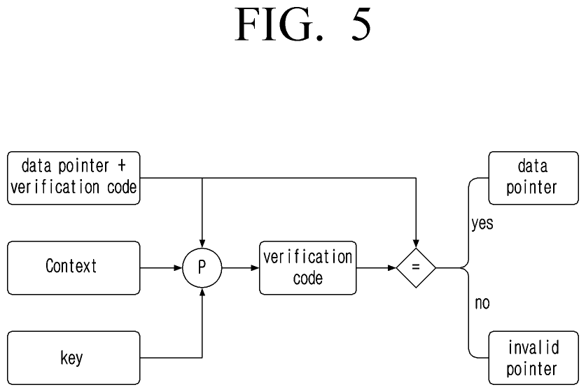

FIG. 5 illustrates a schematic diagram of data pointer address decryption according to an embodiment of the disclosure. Referring to FIG. 5, an incoming encrypted pointer is decrypted by a decryption algorithm to obtain a verification code, which is then compared with a verification code inserted in the pointer. If the verification codes are matched, a valid pointer can be obtained, and if they are not equal, the pointer is an invalid pointer.

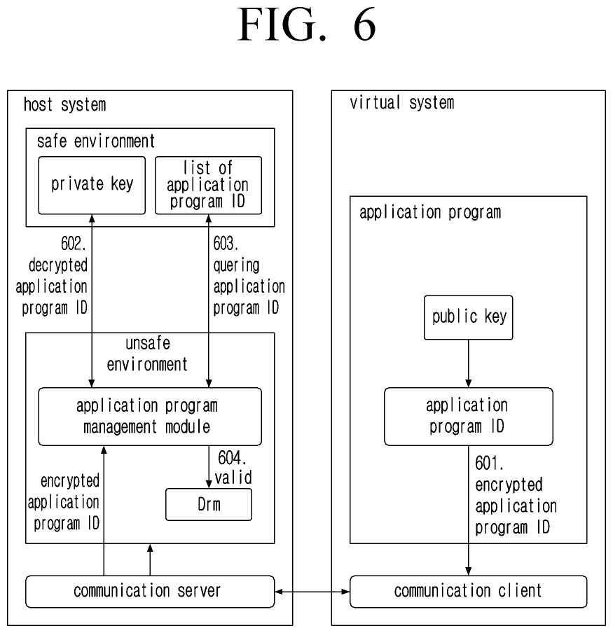

FIG. 6 illustrates a schematic diagram of dynamically managing an application program of a virtual system using digital rights management of a host system, according to an embodiment of the disclosure.

Referring to FIG. 6, at operation 601, an application program identifier (ID) is generated by performing hash processing on unique information identifying the identity of the application program, the application program ID is encrypted with a public certificate, and the encrypted application program ID is sent to the application management module of the host system.

At operation 602, the application program management module decrypts the application program ID with a private certificate to obtain the application program ID.

At operation 603, a list of application program IDs is queried.

At operation 604, if the application program ID is invalid, the application will be denied to access to the host system's digital rights management service DRM; if the application program ID is valid, the host system's digital rights management service DRM can be used.

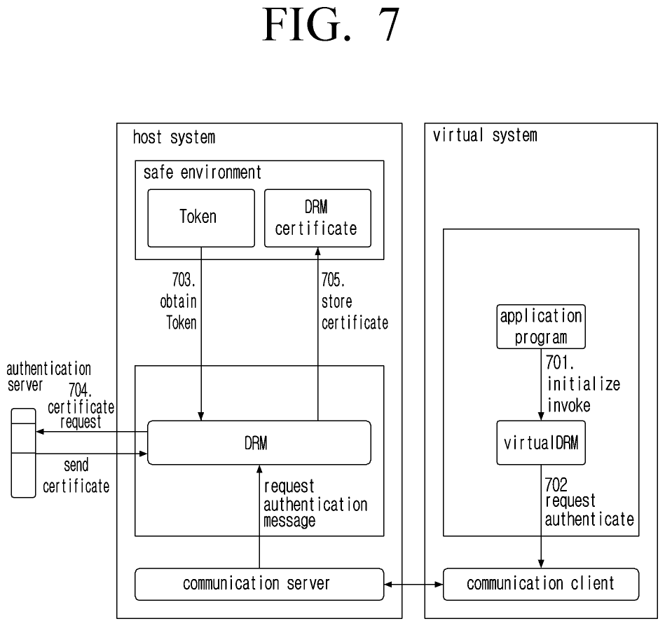

FIG. 7 illustrates a schematic diagram of performing authentication using digital rights management of a host system, according to an embodiment of the disclosure. The virtual system cannot be authenticated without a legitimate token and needs to be authenticated using the host system's digital rights management service DRM.

Referring to FIG. 7, at operation 701, the application program invokes the virtual digital rights management service DRM to initialize its host system's digital rights management service DRM.

At operation 702, the virtual system sends a request for the host system digital rights management service DRM to authenticate.

At operation 703, the host system's digital rights management service DRM obtains a legitimate token.

At operation 704, the host system's digital rights management service DRM generates an authentication request message with the token and sends the authentication request to the server.

At operation 705, the host system obtains the authentication certificate and stores it in the trusted execution environment.

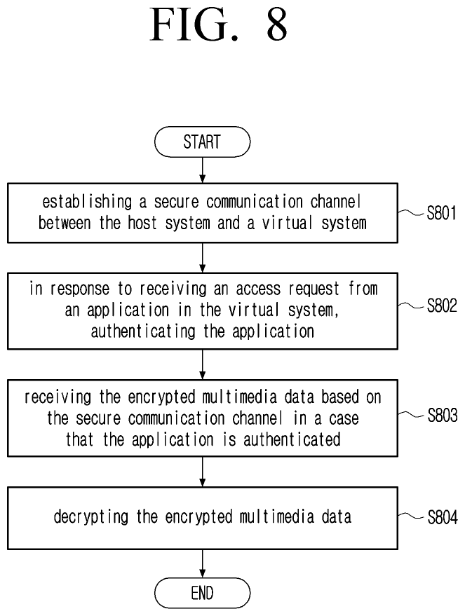

FIG. 8 illustrates a flowchart of an operation method performed by a host system according to an embodiment of the disclosure.

Referring to FIG. 8, in operation S801, a secure communication channel is established between the host system and a virtual system.

In operation S802, in response to receiving an access request from an application in the virtual system, the application is authenticated.

In the embodiment of the disclosure, the authenticating of the application may include: determining whether the application is authorized to make an access; in a case of determining that the application is authorized to make an access, acquiring a certificate for authenticating the application, wherein the virtual system acquires a license file for acquiring the encrypted multimedia data based on the certificate, acquires the encrypted multimedia data based on the license file, and sends the encrypted multimedia data to the host system.

In operation S803, in a case that the application is authenticated, the encrypted multimedia data is received based on the secure communication channel.

In the embodiment of the disclosure, the method may further include: receiving a handle key and/or a data pointer address for decrypting the multimedia data based on the secure communication channel, wherein the handle key and/or the data pointer address for decrypting the multimedia data is in an encrypted state.

In operation S804, the encrypted multimedia data is decrypted.

In the embodiment of the disclosure, the decrypting of the encrypted multimedia data may include: decrypting the encrypted multimedia data in a trusted execution environment.

In the embodiment of the disclosure, the decrypting of the encrypted multimedia data in a trusted execution environment may include: decrypting a data pointer address of the encrypted multimedia data by a decryption algorithm to obtain a second verification code; matching the second verification code with a first verification code; acquiring the data pointer address of the encrypted multimedia data in a case of successful matching of the second verification code with the first verification code.

With the method of multimedia playback for the host system in FIG. 8, it is enabled to request the playback of digital rights management resources with higher levels of security for copyright requirements in a virtual system, thus the strength of data protection is improved.

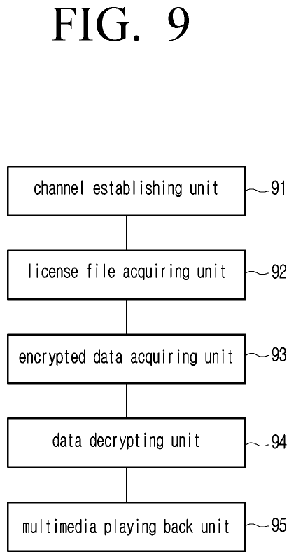

The method of multimedia playback for a virtual system, the operation method performed by a host system according to the embodiments of the disclosure has been described above in conjunction with FIGS. 1 to 8. Hereinafter, the device of multimedia playback for a virtual system and the unit thereof, the operation device performed by a host system according to the embodiments of the disclosure will be described with reference to FIG. 9.

FIG. 9 illustrates a block diagram of a device of multimedia playback for a virtual system according to an embodiment of the disclosure.

Referring to FIG. 9, the device of multimedia playback for the virtual system includes a channel establishing unit 91, a license file acquiring unit 92, an encrypted data acquiring unit 93, a data decrypting unit 94, and a multimedia playing back unit 95.

The channel establishing unit 91 is configured to establish a secure communication channel between the virtual system and a host system.

The license file acquiring unit 92 is configured to acquire a license file for acquiring encrypted multimedia data in a case that an application in the virtual system requesting access to the host system passes authentication of the host system.

In the embodiment of the disclosure, the license file acquiring unit 92 may be configured to determine, by the host system, whether the application is authorized for access by the host system in response to the application requesting access to the host system, in a case of determining that the application is authorized for the access by the host system, to acquire a certificate for authenticating the application by the host system, and to acquire the license file, in the case that the host system is determined to be authenticated based on the certificate.

In the embodiment of the disclosure, the license file acquiring unit 92 may be configured to invoke a second digital rights management service of the host system by a first digital rights management service of the virtual system to acquire the certificate.

In the embodiment of the disclosure, the license file acquiring unit 92 may be configured to determine that the application is authorized for access by the host system, in the event that the application is determined to be a predetermined application.

In the embodiment of the disclosure, the license file acquiring unit 92 may be configured to download the certificate from an authentication server for authentication by invoking the second digital rights management service of the host system by the first digital rights management service of the virtual system.

In the embodiment of the disclosure, the downloaded certificate is stored in the host system.

In the embodiment of the disclosure, the license file acquiring unit 92 may be configured to invoke the second digital rights management service by the first digital rights management service to generate a license request message, and to send the license request message to a license server to obtain the license file.

The encrypted data acquiring unit 93 is configured to acquire the encrypted multimedia data based on the license file.

The data decrypting unit 94 is configured to send the encrypted multimedia data to the host system for decryption based on the secure communication channel.

In the embodiment of the disclosure, the data decrypting unit 94 may be configured to send the encrypted multimedia data to the host system by means of data pointer address encryption in the secure communication channel.

In the embodiment of the disclosure, the device may further include a sending unit (not shown), configured to send a handle key and/or a data pointer address for decrypting the multimedia data to the host system based on the secure communication channel, wherein the handle key and/or the data pointer address for decrypting the multimedia data is in an encrypted state.

The multimedia playing back unit 95 is configured to acquire decrypted multimedia data obtained by decryption by the host system, and playback the decrypted multimedia data.

In the embodiment of the disclosure, the multimedia playing back unit 95 may be configured to determine whether to decrypt the encrypted multimedia data in a trusted execution environment, according to requirements of a usage scenario of the application, and to send the encrypted multimedia data to the host system for decrypting the encrypted multimedia data in the trusted execution environment of the host system, when it is determined to decrypt the encrypted multimedia data in the trusted execution environment.

In the embodiment of the disclosure, the multimedia playing back unit 95 may be configured to process an original value and a key of the data pointer address of the encrypted multimedia data by an encryption algorithm to obtain a cipher text, to insert a first verification code at a predetermined position of the cipher text to obtain a processed cipher text, and to send the processed cipher text to the host system. Wherein, when decrypting the encrypted multimedia data in the trusted execution environment of the host system, the host system decrypts the data pointer address of the encrypted multimedia data by the decryption algorithm to obtain a second verification code, matches the second verification code with the first verification code, and obtains the data pointer address of the encrypted multimedia data in a case of a successful match between the second verification code and the first verification code.

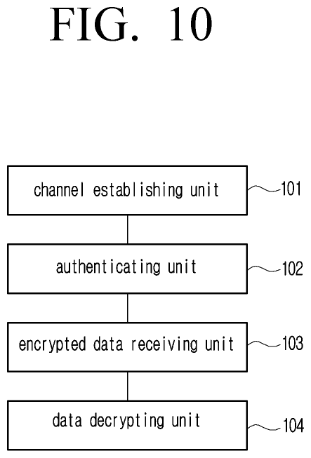

FIG. 10 illustrates a block diagram of an operation device performed by a host system according to an embodiment of the disclosure.

Referring to FIG. 10, the operation device performed by the host system includes a channel establishing unit 101, an authenticating unit 102, an encrypted data receiving unit 103, and a data decrypting unit 104.

The channel establishing unit 101 is configured to establish a secure communication channel between the host system and a virtual system.

The authenticating unit 102 is configured to, in response to receiving an access request from an application in the virtual system, authenticate the application.

In the embodiment of the disclosure, the authenticating unit 102 may be configured to determine whether the application is authorized to make an access, to acquire a certificate for authenticating the application in a case of determining that the application is authorized to make an access, wherein the virtual system acquires a license file for acquiring the encrypted multimedia data based on the certificate, acquires the encrypted multimedia data based on the license file, and sends the encrypted multimedia data to the host system.

The encrypted data receiving unit 103 is configured to receive the encrypted multimedia data based on the secure communication channel in a case that the application is authenticated.

In the embodiment of the disclosure, the device may further include a receiving unit (not shown), configured to receive a handle key and/or a data pointer address for decrypting the multimedia data based on the secure communication channel, wherein the handle key and/or the data pointer address for decrypting the multimedia data is in an encrypted state.

The data decrypting unit 104 is configured to decrypt the encrypted multimedia data.

In the embodiment of the disclosure, the data decrypting unit 104 may be configured to decrypt the encrypted multimedia data in a trusted execution environment.

In the embodiment of the disclosure, the data decrypting unit 104 may be configured to decrypt a data pointer address of the encrypted multimedia data by a decryption algorithm to obtain a second verification code, to match the second verification code with a first verification code, to acquire the data pointer address of the encrypted multimedia data in a case of successful matching of the second verification code with the first verification code.

In addition, according to the embodiments of the disclosure, there also provides a computer-readable storage medium having a computer program stored thereon, and when the computer program is executed, a method of multimedia playback for a virtual system according to the embodiments of the disclosure is implemented.

In the embodiments of the disclosure, the computer-readable storage medium may carry one or more programs that, when executed, may implement the following operations: establishing a secure communication channel between the virtual system and a host system; acquiring a license file for acquiring encrypted multimedia data in a case that an application in the virtual system requesting access to the host system passes authentication of the host system; acquiring the encrypted multimedia data based on the license file; sending the encrypted multimedia data to the host system for decryption based on the secure communication channel; and acquiring decrypted multimedia data obtained by decryption by the host system, and playing back the decrypted multimedia data, thus it is possible to playback digital rights management resources with a higher level of security for copyright requirements in the virtual system by decrypting with the help of the host system, which improves the strength of data protection.

In the embodiments of the disclosure, the computer-readable storage medium may carry one or more programs that, when executed, may implement the following operations: establishing a secure communication channel between the host system and a virtual system; in response to receiving an access request from an application in the virtual system, authenticating the application; receiving the encrypted multimedia data based on the secure communication channel in a case that the application is authenticated; decrypting the encrypted multimedia data.

The computer-readable storage medium can be, for example, but not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In embodiments of the disclosure, a computer-readable storage medium may be any tangible medium that contains or stores a computer program that can be used by or in conjunction with an instruction execution system, apparatus, or device. The computer program contained on the computer-readable storage medium may be transmitted using any appropriate medium, including but not limited to: wire, fiber optic cable, RF (radio frequency), etc., or any suitable combination of the above. The computer-readable storage medium may be included in any device; it may also exist alone without being incorporated into the device.

In addition, according to embodiments of the disclosure, there also provides a computer program product, wherein instructions in the computer program product can be executed by a processor of the computer device to complete the method of multimedia playback for a virtual system according to the embodiments of the disclosure.

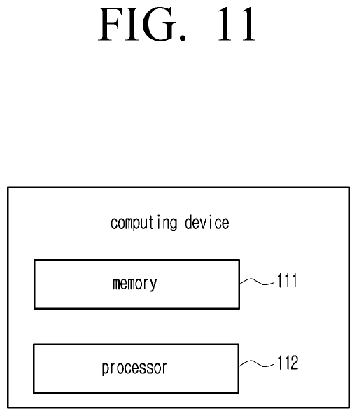

The device of multimedia playback for a virtual system, and the operation device performed by a host system according to the embodiments of the disclosure have been described above in conjunction with FIGS. 9 and 10. Next, a computing device according to the embodiment of the disclosure will be described in conjunction with to FIG. 11.

FIG. 11 illustrates a schematic diagram of a computing device according to an embodiment of the disclosure.

Referring to FIG. 11, a computing device 11 according to the embodiment of the disclosure includes memory 111 and a processor 112, and the memory 111 stores a computer program. When the computer program is executed by the processor 112, a method of multimedia playback for a virtual system according to the embodiments of the disclosure is implemented.

In the embodiments of the disclosure, when the computer program is executed by the processor 112, the following operations may be implemented: establishing a secure communication channel between the virtual system and a host system; acquiring a license file for acquiring encrypted multimedia data in a case that an application in the virtual system requesting access to the host system passes authentication of the host system; acquiring the encrypted multimedia data based on the license file; sending the encrypted multimedia data to the host system for decryption based on the secure communication channel; and acquiring decrypted multimedia data obtained by decryption by the host system, and playing back the decrypted multimedia data, thus it is possible to playback digital rights management resources with a higher level of security for copyright requirements in the virtual system by decrypting with the help of the host system, which improves the strength of data protection.

In the embodiments of the disclosure, when the computer program is executed by the processor 112, the following operations may be implemented: establishing a secure communication channel between the host system and a virtual system; in response to receiving an access request from an application in the virtual system, authenticating the application; receiving the encrypted multimedia data based on the secure communication channel in a case that the application is authenticated; decrypting the encrypted multimedia data.

The computing device in embodiments of the disclosure may include, but are not limited to, devices such as mobile phones, notebook computers, personal digital assistants (PDAs), tablet computers (PADs), desktop computers, and the like. The computing device shown in FIG. 11 is only an example, and should not impose any limitation on the function and scope of use of the embodiments of the disclosure.

The method and device of multimedia playback for a virtual system, and the operation method and device performed by a host system according to the embodiments of the disclosure have been described above with reference to FIGS. 1 to 11. However, it should be understood: the method of multimedia playback for a virtual system and the unit thereof and the operation method performed by a host system shown in FIGS. 9 and 10 may be respectively configured as software, hardware, firmware or any combination of the above to perform specific functions, and the computing device shown in FIG. 11 is not limited to including the above shown components, but some components may be added or deleted according to needs, and the above components may also be combined.

The method and the device of multimedia playback for a virtual system according to the embodiments of the disclosure, by establishing a secure communication channel between the virtual system and a host system, acquiring a license file for acquiring encrypted multimedia data in a case that an application in the virtual system requesting access to the host system passes authentication of the host system, acquiring the encrypted multimedia data based on the license file; sending the encrypted multimedia data to the host system for decryption based on the secure communication channel, and acquiring decrypted multimedia data obtained by decryption by the host system, and playing back the decrypted multimedia data, thus it is possible to playback digital rights management resources with a higher level of security for copyright requirements in the virtual system by decrypting with the help of the host system, which improves the strength of data protection.

In addition, the method and the device of multimedia playback for a virtual system according to the embodiments of the disclosure, improves the strength of data protection without affecting performance by using an inter-module or inter-system encryption protection scheme.

In addition, the method and the device of multimedia playback for a virtual system according to the embodiments of the disclosure can support the playback of multimedia content with multiple security levels, which improves the overall decryption performance of the multimedia, and can increase audio processing scenarios.

In addition, the method and the device of multimedia playback for a virtual system according to the embodiments of the disclosure may further dynamically manage applications of the virtual system to prevent malicious applications from occupying limited digital rights management resources; reuse the host system digital rights management authentication to make the digital rights management of the virtual system usable; and, because the trusted execution environment is based on the hardware environment of the host system, there is no need to separately develop and assign the virtual system with a trusted execution environment.

In addition, the method and the device of multimedia playback for a virtual system according to the embodiments of the disclosure may support all scenarios in which the virtual system requires a trusted execution environment, such as, but not limited to, a digital wallet, a fingerprint payment, an authentication, and the like.

Furthermore, the method and the device of multimedia playback for a virtual system according to the embodiments of the disclosure may be used not only in virtual machines based on containerization technology, but also in virtual machines based on other technologies.

In addition, the method and the device of multimedia playback for a virtual system according to the embodiments of the disclosure are not only limited to be used in digital rights management media resources with high copyright requirements, but may also be applied in virtual machines that require trusted execution environments to support high-level security scenarios, such as digital wallets, payment authentication, identity verification, and the like.

The operation method performed by a host system according to the embodiments of the disclosure, by establishing a secure communication channel between the host system and a virtual system, authenticating the application in response to receiving an access request from an application in the virtual system, receiving the encrypted multimedia data based on the secure communication channel in a case that the application is authenticated, decrypting the encrypted multimedia data, it enables the playback of digital rights management resources with higher levels of security for copyright requirements in a virtual system, thereby increasing the strength of data protection.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of multimedia playback for a virtual system, the method comprising:
establishing a secure communication channel between the virtual system and a host system;
acquiring a license file for acquiring encrypted multimedia data in a case that an application in the virtual system requesting access to the host system passes authentication of the host system;
acquiring the encrypted multimedia data based on the license file;
transmitting the encrypted multimedia data to the host system for decryption based on the secure communication channel; and
acquiring decrypted multimedia data obtained by decryption by the host system, and playing back the decrypted multimedia data.

2. The method of claim 1, wherein the acquiring of the license file for acquiring the encrypted multimedia data in the case that the application in the virtual system requesting access to the host system passes the authentication of the host system comprises:
in response to the application requesting access to the host system, determining, by the host system, whether the application is authorized for access by the host system;
in a case of determining that the application is authorized for the access by the host system, acquiring a certificate for authenticating the application by the host system; and
acquiring the license file, in the case that the host system is determined to be authenticated based on the certificate.

3. The method of claim 2, wherein the acquiring of the certificate comprises:
invoking a second digital rights management service of the host system by a first digital rights management service of the virtual system to acquire the certificate.

4. The method of claim 2, wherein the transmitting of the encrypted multimedia data to the host system for decryption based on the secure communication channel comprises:
transmitting the encrypted multimedia data to the host system by data pointer address encryption in the secure communication channel.

5. The method of claim 3,
wherein the invoking of the second digital rights management service of the host system by the first digital rights management service of the virtual system to acquire the certificate comprises:
downloading the certificate from an authentication server for authentication by invoking the second digital rights management service of the host system by the first digital rights management service of the virtual system, and
wherein a downloaded certificate is stored in the host system.

6. The method of claim 3, wherein the acquiring of the license file comprises:
invoking the second digital rights management service by the first digital rights management service to generate a license request message; and
transmitting the license request message to a license server to obtain the license file.

7. The method of claim 1, wherein the transmitting of the encrypted multimedia data to the host system for decryption based on the secure communication channel comprises:
determining whether to decrypt the encrypted multimedia data in a trusted execution environment, according to requirements of a usage scenario of the application; and
transmitting the encrypted multimedia data to the host system for decrypting the encrypted multimedia data in the trusted execution environment of the host system, when it is determined to decrypt the encrypted multimedia data in the trusted execution environment.

8. The method of claim 1, further comprising:
transmitting a handle key and/or a data pointer address for decrypting the encrypted multimedia data to the host system based on the secure communication channel,
wherein the handle key and/or the data pointer address for decrypting the encrypted multimedia data is in an encrypted state.

9. The method of claim 4,
wherein the transmitting of the encrypted multimedia data to the host system by use of the data pointer address encryption comprises:
processing an original value and a key of a data pointer address of the encrypted multimedia data by an encryption algorithm to obtain a cipher text,
inserting a first verification code at a predetermined position of the cipher text to obtain a processed cipher text, and
transmitting the processed cipher text to the host system, and
wherein, when decrypting the encrypted multimedia data in a trusted execution environment of the host system, the host system comprises:
decrypting the data pointer address of the encrypted multimedia data by a decryption algorithm to obtain a second verification code,
matching the second verification code with the first verification code, and
obtaining the data pointer address of the encrypted multimedia data in a case of a successful match between the second verification code and the first verification code.

10. An operation method performed by a host system comprising:
establishing a secure communication channel between the host system and a virtual system;
in response to receiving an access request from an application in the virtual system, authenticating the application;
receiving encrypted multimedia data based on the secure communication channel in a case that the application is authenticated; and
decrypting the encrypted multimedia data.

11. The method of claim 10,
wherein the authenticating of the application comprises:
determining whether the application is authorized to make an access, and
in a case of determining that the application is authorized to make an access, acquiring a certificate for authenticating the application, and wherein the virtual system comprises:
acquiring a license file for acquiring the encrypted multimedia data based on the certificate,
acquiring the encrypted multimedia data based on the license file, and
transmitting the encrypted multimedia data to the host system.

12. The method of claim 10, wherein the decrypting of the encrypted multimedia data comprises:
decrypting the encrypted multimedia data in a trusted execution environment.

13. The method of claim 12, wherein the decrypting of the encrypted multimedia data in a trusted execution environment comprises:
decrypting a data pointer address of the encrypted multimedia data by a decryption algorithm to obtain a second verification code;
matching the second verification code with a first verification code; and
acquiring the data pointer address of the encrypted multimedia data in a case of successful matching of the second verification code with the first verification code.

14. The method of claim 10, further comprising:
receiving a handle key and/or a data pointer address for decrypting the encrypted multimedia data based on the secure communication channel,
wherein the handle key and/or the data pointer address for decrypting the encrypted multimedia data is in an encrypted state.

15. A device of multimedia playback for a virtual system, comprising:
a channel establisher configured to establish a secure communication channel between the virtual system and a host system;
a license file acquirer configured to acquire a license file for acquiring encrypted multimedia data in a case that an application in the virtual system requesting access to the host system passes authentication of the host system;
an encrypted data acquirer configured to acquire the encrypted multimedia data based on the license file;
a data decrypter configured to transmit the encrypted multimedia data to the host system for decryption based on the secure communication channel; and
a multimedia playing back circuit configured to:
acquire decrypted multimedia data obtained by decryption by the host system, and
playback the decrypted multimedia data.

16. The device of claim 15, wherein the license file acquirer is further configured to:
in response to the application requesting access to the host system, determine, by the host system, whether the application is authorized for access by the host system,
in a case of determining that the application is authorized for the access by the host system, acquire a certificate for authenticating the application by the host system, and
acquire the license file, in the case that the host system is determined to be authenticated based on the certificate.

17. The device of claim 16, wherein the license file acquirer is further configured to:
invoke a second digital rights management service of the host system by a first digital rights management service of the virtual system to acquire the certificate.

18. The device of claim 16, wherein the data decrypter is further configured to:
transmit the encrypted multimedia data to the host system by means of data pointer address encryption in the secure communication channel.

19. The device of claim 17, wherein the license file acquirer is further configured to:
download the certificate from an authentication server for authentication by invoking the second digital rights management service of the host system by the first digital rights management service of the virtual system, and
wherein a downloaded certificate is stored in the host system.

20. The device of claim 17, wherein the license file acquirer is further configured to:
invoke the second digital rights management service by the first digital rights management service to generate a license request message; and
transmit the license request message to a license server to obtain the license file.
